(19) United States
(12) Patent Application Publication
(10) Pub. No.: US 2007/0274469 A1
(43) Pub. Date: Nov. 29, 2007

(54) Systems and methods for providing direct-to-voicemail functionality

(76) Inventors: Todd C. Lesko, Aliso Viejo, CA (US); Jonathan M. Lindsay, Rancho Santa Margarita, CA (US)

Correspondence Address: Jonathan M. Lindsay, 20th Floor, 3 Park Plaza, Irvine, CA, 92614, US

(21) Appl. No.: 11/432,900

(22) Filed: May 12, 2006

(51) Int. Cl. H04M 1/64

(52) U.S. Cl. 379/67.1

(57) ABSTRACT

By entering a feature access code prior to placing a call, a calling party can have a call terminated directly to the voicemail of the called party. In one embodiment, entering the feature access code, followed by the called party's directory number, will cause the call to be routed directly to the called party's voicemail system, without ever ringing through to the called party's subscriber line. In another embodiment, a called party may subscribe to a service which blocks attempts by calling parties to invoke the aforementioned direct-to-voicemail feature.

### FIELD OF THE INVENTION

This invention relates generally to voicemail systems, and in particular to a system and method for providing direct-to-voicemail functionality to a calling party.

### BACKGROUND

Oftentimes in life, we may owe someone a return phone call, or otherwise want to provide them with some information, while not necessarily wanting to engage them in a conversation. For example, we might be too busy, be too tired or simply want to avoid a full-blown conversation, but still desire to provide the called party with some information or simply satisfy our obligation to make the return call. Heretofore, the calling party was relegated to making the phone call, and simply hoping to get the called party's voicemail. However, all too often, the called party would answer the call and engage the calling party in a conversation the latter did not want to have. As such, there is a need in the art for a feature that allows calling parties to request to be placed directly into a called party's voicemail system, without ever having the called party's subscriber line ring.

As more and more people use the “direct to voicemail” feature described above, calling parties may become increasing frustrated because they are going to have messages dumped directly into their voicemail systems without ever having the ability to answer the calls. The obligation to return a call will have been “placed in the court” of the called party—a notion that can be very frustrating, especially if the called party really wanted to talk to the calling party who was placed directly into the called party's voicemail. Thus, there will also be a need for a feature that serves to block the ability of a calling party to go directly into a called party's voicemail system without first providing the called party with the opportunity to answer the incoming call.

### SUMMARY

Disclosed and claimed herein are systems and methods for providing direct-to-voicemail functionality to a calling party. In one embodiment, a method for routing a telephone call directly to voicemail includes receiving a feature access code from a calling party subscriber line, and receiving a directory number from the calling party subscriber line that corresponds to a called party subscriber line. The method further includes routing, in response to the feature access code, the telephone call to a voicemail system of the called party subscriber line.

Other aspects, features, and techniques of the invention will be apparent to one skilled in the relevant art in view of the following detailed description of the invention.

### BRIEF DESCRIPTION OF THE DRAWINGS

FIG. 1 depicts one embodiment of a simplified telecommunications system for implementing one or more aspects of the invention; and

FIG. 2 is a diagram for one embodiment of a process for implementing a direct-to-voicemail feature.

### DETAILED DESCRIPTION OF THE EXEMPLARY EMBODIMENTS

Disclosed herein are systems and methods for providing a direct-to-voicemail (DVM) feature. In particular, if a calling party desires to leave a called party a message, but wants to insure that he does not have to talk directly to the called party, the calling party may enter a feature access code prior to dialing the called party's telephone number. This feature access code will serve as a trigger to cause the call to terminate directly to the called party's voicemail system, without ever ringing through to the called party's subscriber line, even if the subscriber line is otherwise idle.

The aforementioned DVM feature is applicable to any voicemail service, such as the voicemail service typically used by cellular telephone subscribers. It is also applicable to landline subscribers who use the digital voicemail service provided my most telephone companies (e.g., BellSouth MemoryCall Voice Mail Service™ offered by BellSouth Corporation of Atlanta Ga.).

Another aspect of the invention is to provide the ability of a called party to block an attempt, by a calling party, to invoke the DVM feature. Specifically, a subscriber will be able to invoke, or otherwise implement, a DVM block feature such that when a calling party attempts to invoke the DVM feature access code, the calling party will not be routed directly to the called party's voicemail service, but rather will receive a message saying, for example, “I'm sorry. This subscriber does not allow calls to be placed directly to voicemail. Please hang up and try your call again.”

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. The particular features, structures, or characteristics may be combined in any suitable manner on one or more embodiments without limitation. Furthermore, the terms “voicemail,” “voicemail service,” and “voicemail system” may be used interchangeably throughout this disclosure.

The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

DVM Feature

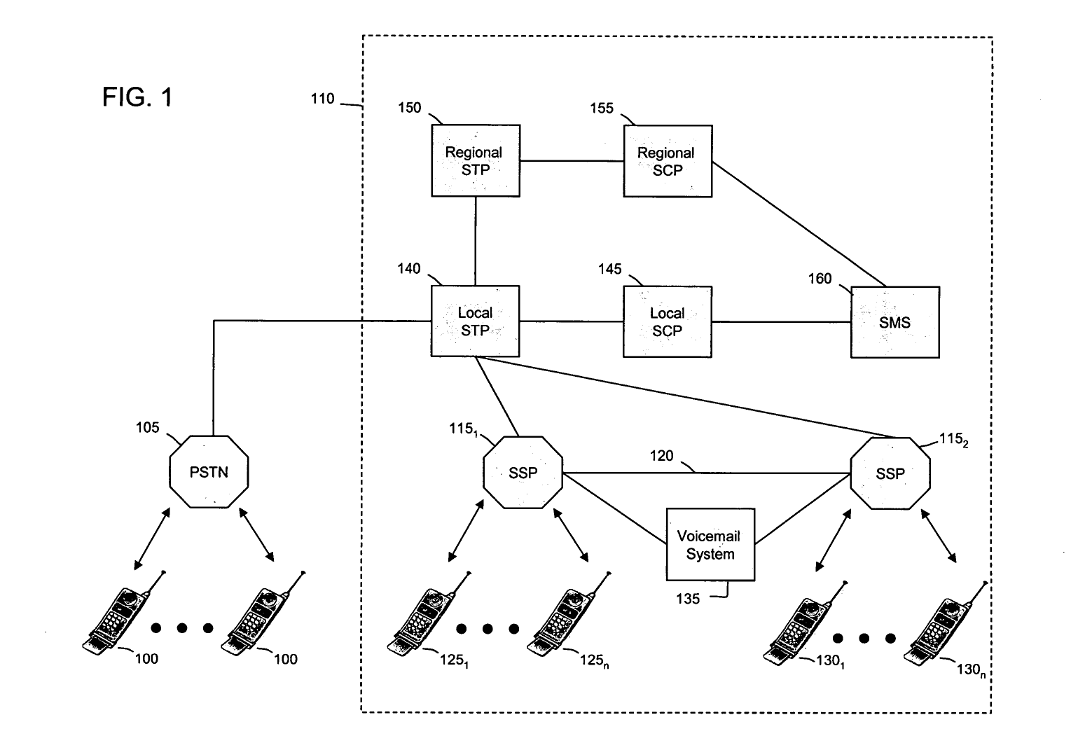

FIG. 1 is a simplified diagram of an exemplary system in which one or more aspects of the invention may be implemented. As shown, a public switched telecommunication network (PSTN) 105 is connected to an Advanced Intelligent Network (AIN) 110, as is generally known in the art.

The AIN 110 includes numerous elements, including the plurality of central offices indicated as service switching points (SSPs) 115₁ and 115₂. An SSP typically includes switch functionality, but may also include other functionality so as to communicate with other AIN 110 elements, as understood by those skilled in the art. While SSP 115₁ is shown as being connected to SSP 115₂ by trunk line 120, trunk line 120 may similarly connect a plurality of other SSPs to each other. Trunk line 120 functions as a voice path interconnecting two or more SSPs. Although only two SSPs are depicted in FIG. 1, it should equally be appreciated that the AIN 110 may include many more.

As further depicted, the SSP 115₁ has a plurality of subscribers 125₁-125ₙ connected thereto. Similarly, SSP 115₂ is shown as having a plurality of connected subscribers 130₁-130ₙ. In this fashion, each SSP serves a designated group of calling lines or subscribers.

FIG. 1 further shows the AIN 110 as including a voicemail system (VMS) 135 connected to each of SSP 115₁ and SSP 115₂. It should of course be understood that the VMS 135 may alternatively serve a single SSP, or multiple SSPs.

The VMS is a digital service that provides subscribers the ability to record, store and retrieve voice messages from and to other subscribers. By being implemented at or connected to an SSP, the VMS 135 is connected to the PSTN 105 and, as such, may serve more than one subscriber or calling line. Moreover, even though VMS 135 may be implemented at or connected to a particular SSP, the VMS 135 may also serve subscribers being served by SSPs other than the SSP through or to which the VMS 135 is connected.

Continuing to refer to FIG. 1, each of SSP 115₁ and SSP 115₂ is depicted as being connected to a local signal transfer point (STP) 140 via respective data links. In one embodiment, these data links employ a signaling protocol referred to as Signaling System 7 (SS7), as will be understood by those skilled in the art. Another element of the AIN 110 is an element referred to as a local service control point (SCP) 145 that is connected to local STP 140 over an SS7 data link. The local SCP 145 performs a maintenance function for subscriber databases usable to provide advanced services to subscribers. Typically, the local SCP 145 is also the repository for service package applications (SPAs) that are used in connection with or as part of the subscriber databases in providing the advanced services. The local STP 140 may be connected to a regional STP 150, which in turn, may be connected to a regional SCP 155. Both regional SCP 155 and local SCP 145 may be connected to what is known as a service management system (SMS) 160. The SMS 160 may be used to interface local exchange carriers and interexchange carriers.

The aforementioned SSPs 115₁ and/or 115₂ are configured to recognize a set of customized dialing plan (CDP) triggers initiated by a subscriber line. A trigger in an AIN system (e.g., AIN 110) is an event associated with a particular calling line that generates a query to be sent to a corresponding local SCP (e.g., local SCP 145). The trigger causes the SCP to make an inquiry of its databases or SPA for information and/or processing instructions with respect to the particular call. The results are sent back to the inquiring SSP (e.g., SSP 115₁ or SSP 115₂) in a response from the SCP through a local STP (e.g., local STP 140). The response may include information and/or instructions to the SSP as to how to process the call. The instructions may be to take some special action as a result of an advanced service or enhanced feature. In response, the SSP moves through its call states, collects the called digits, and generates further packets that are used to set up and route the call. Similar devices for routing calls among various local exchange carriers are provided by regional STP 150 and regional SCP 155.

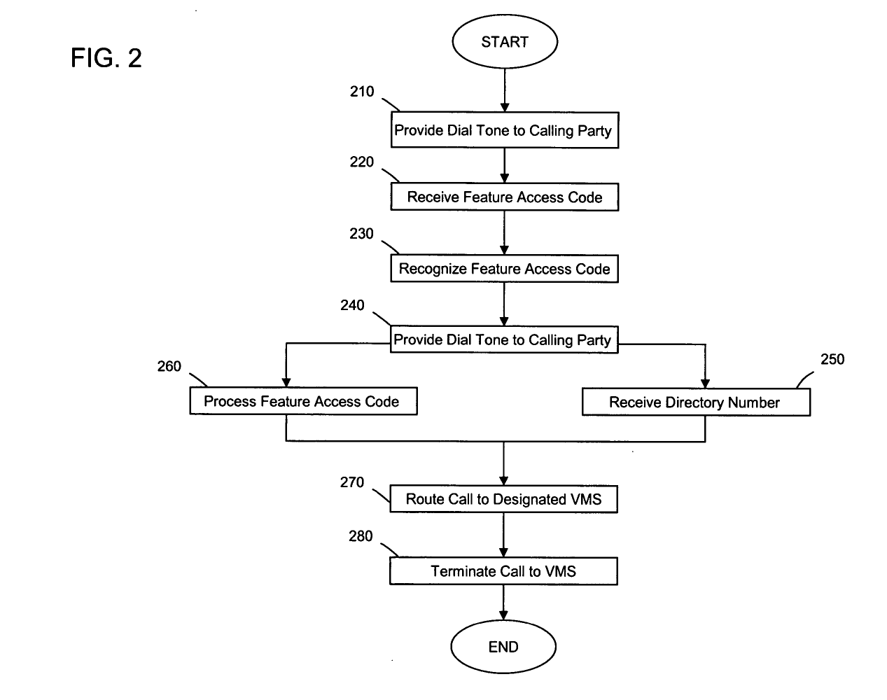

Referring now to FIG. 2, depicted is one embodiment of a process 200 for implementing the invention. In particular, process 200 begins at block 210 with the calling party receiving the standard dial tone upon placing the calling party's equipment in an off-hook position, or otherwise placing the equipment in a dial-ready mode. At this point, the calling party may enter a feature access code, which is received by their SSP (e.g., SSP 115₁ or SSP 115₂) at block 220. Thereafter, at block 230, a determination will be made as to whether the received feature access code is a recognized valid code or not. If the entered feature access code is valid, the calling party will again be provided with a dial tone at block 240, in typical fashion. At this point, the calling party will enter the called party's directory number (DN) at block 250. Either simultaneously with the entry of the DN information or subsequently thereto, the calling party's SSP will proceed to process the received feature access code by, for example, obtaining additional call processing information (block 260). As discussed above, the feature access code is recognized via a trigger by the calling party's SSP, or possibly another network element (e.g., local SCP). In one embodiment, the feature access code may commence with the calling party pressing the * of their calling device, followed by the entry of any two-digit code (e.g., *11). However, it should equally be appreciated that the system may be programmed to recognize feature access codes beginning with inputs other than *, and may be followed by codes having more or fewer than two digits.

While the received feature access code may be processed in a number of ways, in one embodiment the SSP may obtain the instructions for processing the call through a query/response exchange with a local SCP (e.g., local SCP 145). Namely, the SSP may launch a query to the local SCP which includes the feature access code and optionally the DN information. It should be appreciated that the query may include other information as well.

Upon receipt of the query from the SSP, the SCP (or appropriate SPA) will recognize that the feature access code corresponds to the DVM feature and, accordingly, will instruct the SSP to route the call to the called party's VMS (e.g., VMS 135). The called party's VMS is whatever voicemail service is associated with the designated DN. Moreover, it should be appreciated that other SCPs may be involved at different points in the exemplary process 200.

At block 270, the SSP will then route the call directly to the designated VMS for the called party in accordance with the call processing instructions received by the local SCP, or other network element. In one embodiment, the SSP connects the call through a trunk line to the called party's VMS. In accordance with one embodiment of the invention, the call may be routed to the designated VMS without regard to the availability of the called party, and without ringing the call through to the called party's subscriber line. In this fashion, a voicemail may be left for the called party without providing the called party with the opportunity to answer an incoming call.

Once the call has been routed to the called party's VMS, the call may terminate to the VMS system in the normal fashion (block 280). In some cases, additional information (e.g., caller ID) may also be provided to the called party's VMS. The called party may also be alerted to the presence of a waiting voicemail, as is generally known in the art.

DVM Block & Other Features

As mentioned above, another aspect of the invention is to provide the ability of a called party to block an attempt, by a calling party, to invoke the DVM feature. To that end, another aspect of the invention is to provide a subscriber with a service which detects and thwarts attempts to invoke the DVM feature. In one embodiment, this may be implemented by programming the local or remote SCP with the information that a particular subscriber does not want calls automatically directed to voicemail. Thus, when an SSP launches a query to the appropriate SCP, as described above with reference to FIG. 2, the SCP (or an appropriate SPA) will recognize that the calling party is attempting to invoke the DVM feature. However, since the SCP includes a database for subscriber feature services, it will detect that the called party has invoked the DVM block feature, and will accordingly instruct the SSP to play a pre-recorded message to the calling party informing them of this fact. It should further be appreciated that the SCP may provide additional call processing instructions to the SSP.

Additional options may also be provided to the calling party in conjunction with the DVM feature. For example, after recording a voicemail to be delivered directly to the called party's voicemail system, a calling party may be given one or more delivery options. In one embodiment, one such delivery option may be to enable the calling party to identify a particular time and/or date for delivery of the recorded voicemail to the voicemail system of the called party. Another possible option may be to provide the calling party with the ability to re-record or edit the message if the calling party is not happy with the previous recording. In still another embodiment, the calling party may also be provided with the ability to have the called party's equipment indicate that a call was missed despite having the voicemail sent directly to the called party's voicemail system.

While the invention has been described in connection with various embodiments, it will be understood that the invention is capable of further modifications. This application is intended to cover any variations, uses or adaptations of the invention following, in general, the principles of the invention, and including such departures from the present disclosure within the known and customary practice in the art to which the invention pertains.

What is claimed is:

1. A method for terminating a calling party's telephone call directly to a voicemail service of a called party, comprising:
receiving a feature access code entered by the calling party;
receiving a directory number corresponding to the called party entered by the calling party;
processing the feature access code as a request to terminate the telephone call directly to the voicemail service of the called party; and
routing, in response to the feature access code, the telephone call to the voicemail service of the called party.

2. The method of claim 1, further comprising:
providing a first dial tone to the calling party prior to receiving the feature access code; and
providing a second dial tone to the calling party after receiving the feature access code and before receiving the directory number.

3. The method of claim 1, wherein the feature access code comprises a trigger of a customized dialing plan.

4. The method of claim 1, wherein processing the feature access code comprises:
generating a query by a service switching point of the calling party;
sending the query to a corresponding local service control point;
performing a database inquiry by the local service control point in response to the query; and
providing call processing instructions to the service switching point based on a result of the database inquiry.

5. The method of claim 4, wherein providing call processing instructions comprises providing instructions to the service switching point that the telephone call is to be routed directly to the voicemail service of the called party without providing the called party an opportunity to answer the telephone call.

6. The method of claim 1, wherein routing comprises routing the telephone call to the voicemail service of the called party unless the called party has invoked a blocking service, in which case the method further comprises terminating the telephone call with a message indicating that the telephone call will not be routed to the voicemail service.

7. The method of claim 1, further comprising identifying the voicemail service of the called party using the directory number.

8. A system for routing a telephone call directly to voicemail, comprising:
a calling party subscriber line coupled to a telecommunication network;
a called party subscriber line coupled to the telecommunication network;
a voicemail system associated with the called party subscriber line, the voicemail system being coupled to the telecommunication network; and
a service switching point associated with the calling party subscriber line coupled to the telecommunication network, wherein the service switching point is configured to,
receive a feature access code from the calling party subscriber line,
receive a directory number from the calling party subscriber line that corresponds to the called party subscriber line, and
route, in response to the feature access code, the telephone call over the telecommunication system to the voicemail system associated with the called party subscriber line.

9. The system of claim 8, wherein the service switching point is further configured to,
provide a first dial tone to the calling party subscriber line prior to having received the feature access code, and
provide a second dial tone to the calling party subscriber line after having received the feature access code and before having received the directory number.

10. The system of claim 8, wherein the service switching point is further configured to generate a query based on the feature access code, the system further comprising:
a corresponding local service control point configured to,
receive said query from the service switching point over the telecommunication network,
perform a database inquiry in response to the query, and
provide call processing instructions to the service switching point based on a result of the database inquiry.

11. The system of claim 10, wherein the call processing instructions instruct the switching point to route the telephone call directly to the voicemail system without the called party subscriber line ringing.

12. The system of claim 8, wherein the telephone call is routed to the voicemail system unless the called party subscriber line has invoked a blocking service, in which case the service switching point is further configured to provide a recorded message to the calling party subscriber line indicating that the telephone call will not be directed to the voicemail system.

13. The system of claim 8, wherein the directory number is used to identify the voicemail system of the called party subscriber line.

14. A method for routing a telephone call directly to voicemail, comprising:
receiving a feature access code from a calling party subscriber line;
receiving a directory number from the calling party subscriber line that corresponds to a called party subscriber line; and
routing, in response to the feature access code, the telephone call to a voicemail system of the called party subscriber line.

15. The method of claim 14, further comprising:
providing a first dial tone to the calling party subscriber line prior to receiving the feature access code; and
providing a second dial tone to the calling party subscriber line after receiving the feature access code and before receiving the directory number.

16. The method of claim 14, further comprising:
generating, by a service switching point, a query based on the feature access code;
receiving said query from the service switching point by a corresponding local service control point over a telecommunications network;
performing a database inquiry in response to the query; and
providing call processing instructions to the service switching point by the corresponding local service control point based on a result of the database inquiry.

17. The method of claim 16, wherein providing the call processing instructions comprises instructing the service switching point to route the telephone call directly to the voicemail system without causing the called party subscriber line to ring.

18. The method of claim 14, wherein routing comprises routing the telephone call to the voicemail system unless the called party subscriber line has implemented a blocking feature, in which case the method further comprises providing a recorded message to the calling party subscriber line indicating that the telephone call will not be routed to the voicemail system.

19. The method of claim 14, further comprising identifying the voicemail system of the called party using the directory number.
